(19) United States
(12) Patent Application Publication
(10) Pub. No.: US 2023/0382473 A1
(43) Pub. Date: Nov. 30, 2023

(54) Trailer Tandem Slide Stopping Device And Method Of Use

(71) Applicant: Jeffrey Olson, Canyonville, OR (US)

(72) Inventor: Jeffrey Olson, Canyonville, OR (US)

(21) Appl. No.: 17/752,402

(22) Filed: May 24, 2022

(51) Int. Cl. B62D 53/06

(52) U.S. Cl. CPC B62D 53/068

(57) ABSTRACT

A trailer tandem slide stopping device for facilitating positioning of a trailer tandem includes a guide pin, which insertable into a first hole of a plurality of holes positioned in an outer rail attached to a the trailer. The first hole is positioned past either a rearward or forward end of an inner rail of the tandem trailer. The guide pin abuts the rearward or forward end of the inner rail upon driving a semitruck hitched to the trailer in forward or reverse, respectively, to move the trailer tandem toward the rear or front of the trailer, respectively, at which point a locking pin of the trailer tandem is aligned with and positioned for insertion into a target hole of the plurality of holes. The target hole corresponds to a desired position of the trailer tandem relative to the trailer.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to stopping devices and more particularly pertains to a new stopping device for facilitating positioning of a trailer tandem. The present invention discloses a stopping device for a trailer tandem that reduces requirements upon an operator by allowing for successful positioning of a trailer tandem without repeated trips by the operator between a cab of a semitruck and a trailer tandem attached to a trailer that is hitched to the semitruck.

### (2) Description of Related Art Including Information Disclosed Under 37 CFR 1.97 and 1.98

The prior art does not teach stopping devices for trailer tandems.

### BRIEF SUMMARY OF THE INVENTION

An embodiment of the disclosure meets the needs presented above by generally comprising a guide pin, which is shaped complementarily to the holes of a plurality of holes positioned in an outer rail attached to a trailer. The first hole is positioned either between a rearward end of an inner rail of the tandem trailer and a rear of the trailer or between a forward end of the inner rail and a front of the trailer. The guide pin is insertable by a first end into the guide hole. A plate is attached to a second end of the guide pin and is configured to abut the outer rail upon insertion of the guide pin into the guide hole. The guide pin is configured to abut the rearward end or the forward end of the inner rail upon driving a semitruck hitched to the trailer in forward or reverse, respectively, to move the trailer tandem toward the rear or front of the trailer, respectively. A locking pin that is attached to the trailer tandem is aligned with and positioned for insertion into a target hole of the plurality of holes. The target hole corresponds to a desired position of the trailer tandem relative to the trailer.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front isometric perspective view of a trailer tandem slide stopping device according to an embodiment of the disclosure.

FIG. 2 is a rear isometric perspective view of an embodiment of the disclosure.

FIG. 3 is a side view of an embodiment of the disclosure.

FIG. 4 is a front view of an embodiment of the disclosure.

FIG. 5 is an in-use view of an embodiment of the disclosure.

FIG. 6 is an in-use view of an embodiment of the disclosure.

FIG. 7 is a flow diagram for a method utilizing an embodiment of the disclosure.

### DETAILED DESCRIPTION OF THE INVENTION

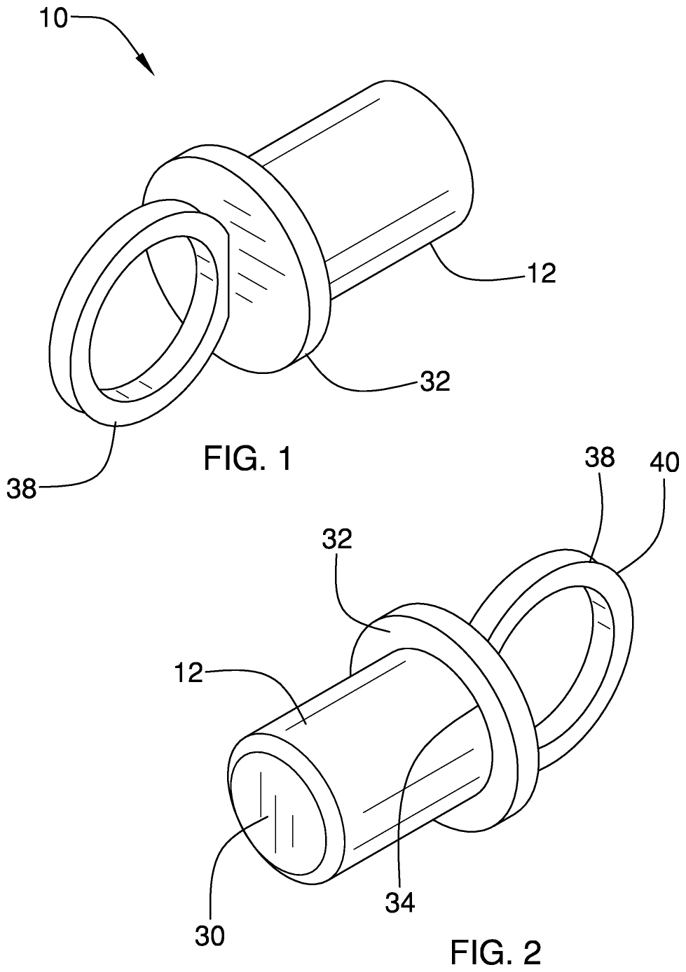

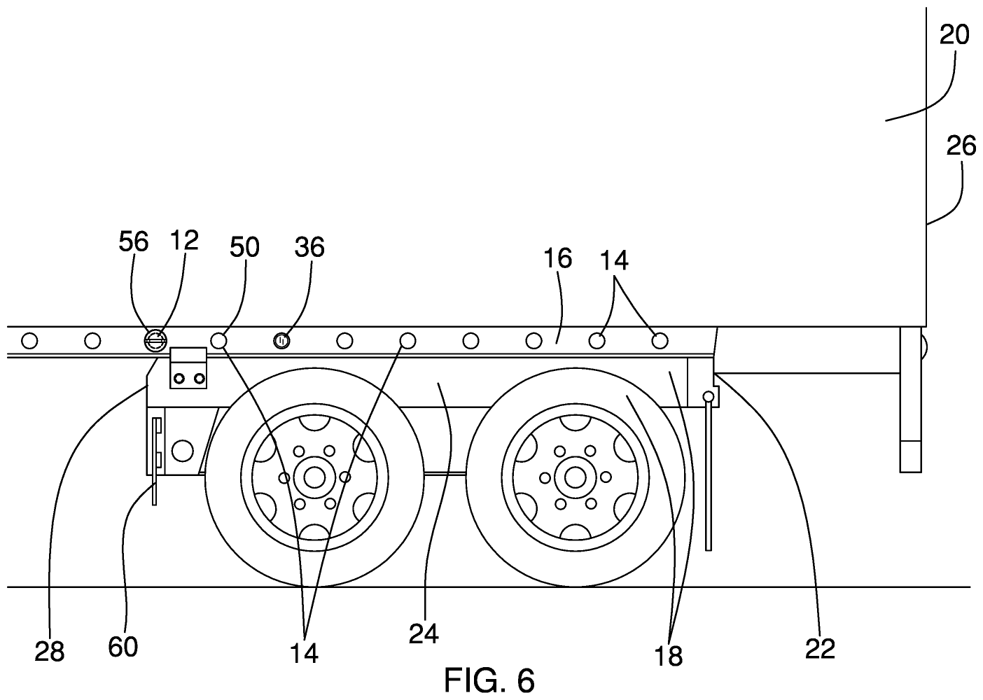

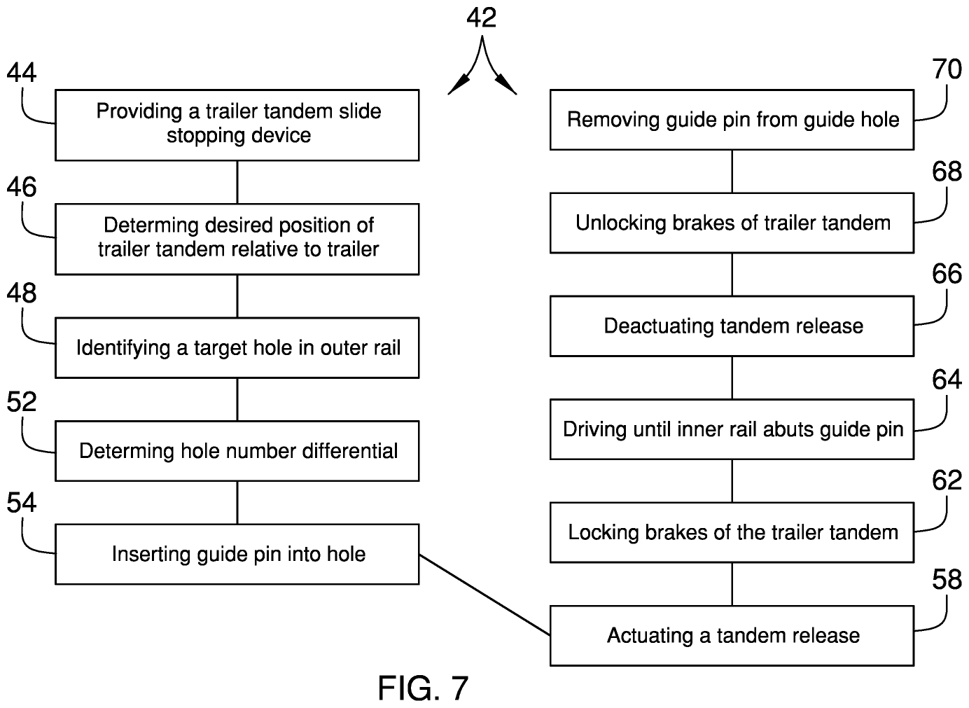

With reference now to the drawings, and in particular to FIGS. 1 through 7 thereof, a new stopping device embodying the principles and concepts of an embodiment of the disclosure and generally designated by the reference numeral 10 will be described.

As best illustrated in FIGS. 1 through 7, the trailer tandem slide stopping device generally comprises a guide pin 12, which is cylindrical and thus shaped complementarily to the holes 14 of a plurality of holes 14 that is positioned in an outer rail 16 attached to a trailer 20. A guide hole 56 amongst the plurality of holes 14 is positioned either between a rearward end 22 of an inner rail 24 of the tandem trailer 20 and a rear 26 of the trailer 20 or between a forward end 28 of the inner rail 24 and a front (not shown) of the trailer 20. The guide pin 12 is insertable by a first end 30 into the guide hole 56. A plate 32, which is circular, is attached to a second end 34 of the guide pin 12 and is configured to abut the outer rail 16 upon insertion of the guide pin 12 into the guide hole 56.

The guide pin 12 is configured to abut the rearward end 22 or the forward end 28 of the inner rail 24 upon driving a semitruck (not shown) hitched to the trailer 20 in forward or reverse, respectively, to move the trailer tandem 18 toward the rear 26 or front of the trailer 20, respectively. A locking pin 36 that is attached to the trailer tandem 18 thus is aligned with and positioned for insertion into a target hole 50 of the plurality of holes 14. The target hole 50 corresponds to a desired position of the trailer tandem 18 relative to the trailer 20.

The trailer tandem slide stopping device 10 enables an operator to change the weight distribution between the semitruck's drive axles and the trailer tandem 18. The operator previously was required to walk back and forth from the trailer tandem 18 and a cab of the semitruck. The present invention may prevent the trailer 20 from moving further than desired when the operator is in the cab and removes uncertainty in achieving a proper legal weight distribution.

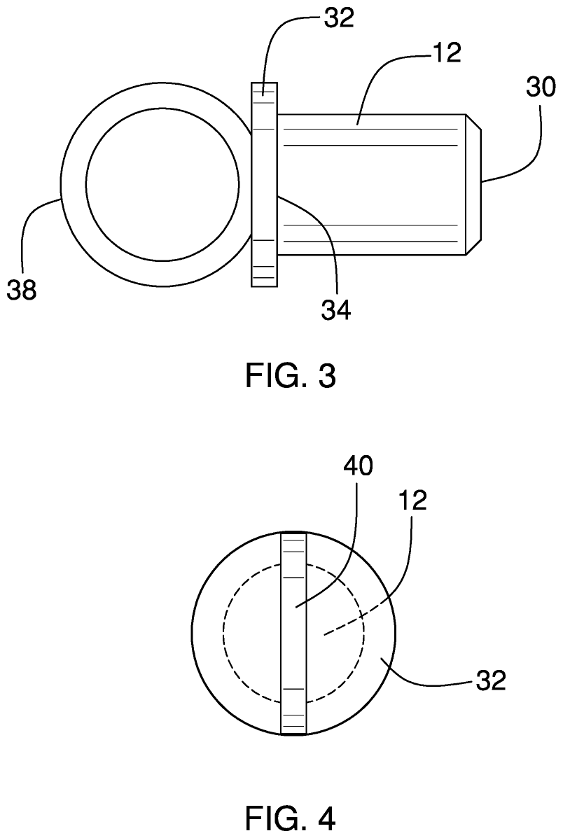

A handle 38 is attached to the plate 32 and is opposing to the guide pin 12. The handle 38 is configured to be grasped in digits or a hand of the user, positioning the user to pull on the handle 38 to extract the guide pin 12 from the guide hole 14. The handle 38 may comprise a ring 40, as shown in FIG. 3, a knob, a loop of wire, or the like. The ring 40 is configured for insertion of a digit of the hand of the user. The ring 40, the guide pin 12, and the plate 32 comprise steel.

The trailer tandem slide stopping device 10 enables a method to selectively position a trailer tandem relative to a trailer to which it is attached 42. The method 42 comprises a first step 44 of providing a trailer tandem slide stopping device 10 according to the specification above. A second step 46 of the method 42 is determining a desired position of the trailer tandem 18 relative to the trailer 20. A third step 48 of the method 42 is identifying a target hole 50 amongst the plurality of holes 14 in the outer rail 16. The target hole 50 most closely corresponds to the desired position of the trailer tandem 18. A locking pin 36 attached to the trailer tandem 18 is to be inserted into the target hole 50.

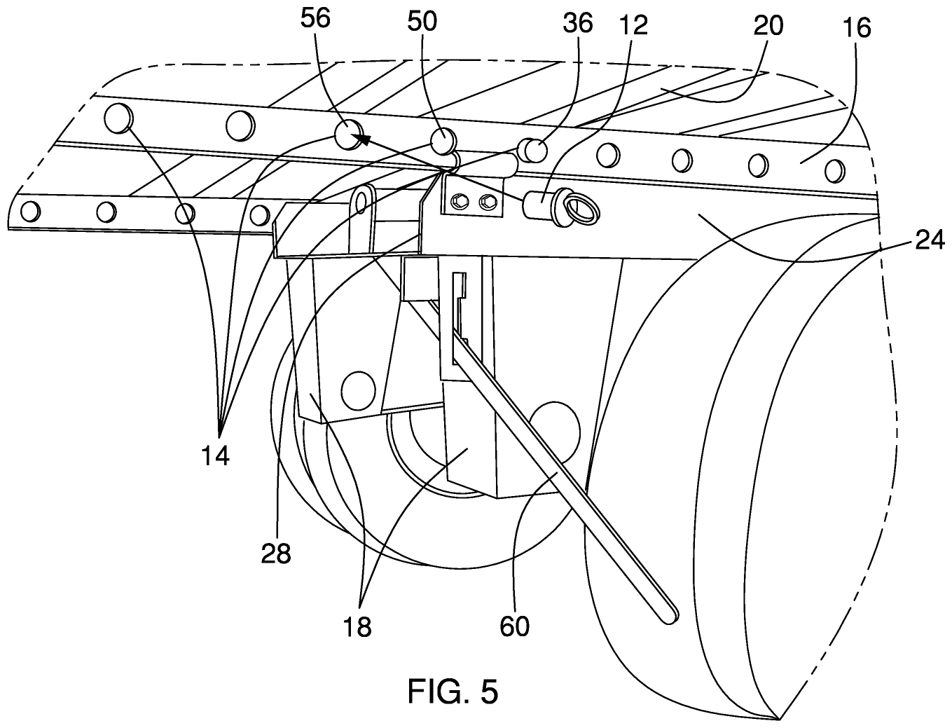

A fourth step 52 of the method 42 is determining a hole number differential between the target hole 50 and the hole 14 currently occupied by the locking pin 36. For example, in FIG. 5, the hole number differential was determined to be one. A fifth step 54 of the method 42 is inserting the guide pin 12 into a guide hole 56 that is spaced from a rearward end 22 or a forward end 28 of the inner rail 24 by the hole number differential. The guide hole 56 is between a rearward end 22 of the inner rail 24 and a rear 26 of the trailer 20 when adjusting the trailer tandem 18 toward the rear 26 of the trailer 20. As shown in FIG. 5, the guide hole 56 is between a forward end 28 of the inner rail 24 and a front of the trailer 20 when adjusting the trailer tandem 18 toward the front of the trailer 20.

A sixth step 58 of the method 42 is actuating a tandem release 60 to extract the locking pin 36 from the hole 14 into which it was previously inserted. A seventh step 62 of the method 42 is locking the brakes (not shown) of the trailer tandem 18. An eighth step 64 of the method 42 is driving a semitruck (not shown) that is hitched to the trailer 20 in forward or reverse to move the trailer tandem 18 toward the rear 26 or the front of the trailer 20, respectively, until the rearward end 22 or the forward end 28 of the inner rail 24 abuts the guide pin 12, at which point the target hole 50 is aligned with the locking pin 36. A ninth step 66 of the method 42 is deactuating the tandem release 60 to insert the locking pin 36 into the target hole 50. A tenth step 68 of the method 42 is unlocking the brakes of the trailer tandem 18. An eleventh step of the method is removing the guide pin 12 from the guide hole 56. It will be understood by those skilled in the art of positioning trailer tandems 18 that the ordering of the steps of the method 42 can be altered.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A trailer tandem slide stopping device comprising:
a guide pin shaped complementarily to the holes of a plurality of holes positioned in an outer rail attached to a trailer, a guide hole amongst the plurality of holes being positioned either between a rearward end of an inner rail of the tandem trailer and a rear of the trailer or between a forward end of the inner rail and a front of the trailer, such that the guide pin is insertable by a first end into the guide hole;
a plate attached to a second end of the guide pin, wherein the plate is configured for abutting the outer rail upon insertion of the guide pin into the guide hole; and
wherein the guide pin is configured for abutting the rearward end or the forward end of the inner rail upon driving a semitruck hitched to the trailer in forward or reverse, respectively, for moving the trailer tandem toward the rear or front of the trailer, respectively, such that a locking pin attached to the trailer tandem is aligned with and positioned for insertion into a target hole of the plurality of holes, the target hole corresponding to a desired position of the trailer tandem relative to the trailer.

2. The trailer tandem slide stopping device of claim 1, wherein the guide pin is cylindrical.

3. The trailer tandem slide stopping device of claim 1, wherein the plate is circular.

4. The trailer tandem slide stopping device of claim 1, further including a handle attached to the plate and being opposing to the guide pin, wherein the handle is configured for grasping in digits or a hand of the user, positioning the user for pulling on the handle for extracting the guide pin from the guide hole.

5. The trailer tandem slide stopping device of claim 4, wherein the handle comprises a ring configured for insertion of a digit of the hand of the user.

6. The trailer tandem slide stopping device of claim 5, wherein the ring, the guide pin, and the plate comprise steel.

7. A method for selectively positioning a trailer tandem relative to a trailer to which it is attached, the method comprising the steps of:
providing a trailer tandem slide stopping device comprising:
a guide pin shaped complementarily to the holes of a plurality of holes positioned in an outer rail attached to a trailer, such that the guide pin is insertable by a first end into a guide hole amongst the plurality of holes, the guide hole being selected by an operator, and
a plate attached to a second end of the guide pin, wherein the plate is configured for abutting the outer rail upon insertion of the guide pin into the guide hole;
determining a desired position of the trailer tandem relative to the trailer;
identifying a target hole amongst the plurality of holes in the outer rail most closely corresponding to the desired position of the trailer tandem, into which a locking pin attached to the trailer tandem is to be inserted;
determining a hole number differential between the target hole and a hole currently occupied by the locking pin;
inserting the guide pin into a guide hole spaced from a rearward end or a forward end of an inner rail attached to the trailer tandem by the hole number differential, the guide hole being between a rearward end of the inner rail and a rear of the trailer or between a forward end of the inner rail and a front of the trailer, when adjusting the trailer tandem toward the rear or the front of the trailer, respectively;
actuating a tandem release to extract the locking pin from the hole into which it was previously inserted;
locking the brakes of the trailer tandem;
driving a semitruck hitched to the trailer in forward or reverse for moving the trailer tandem toward the rear or front of the trailer, respectively, until the rearward end or the forward end of the inner rail abuts the guide pin, at which point the target hole is aligned with the locking pin;
deactuating the tandem release for inserting the locking pin into the target hole;
unlocking the brakes of the trailer tandem; and
removing the guide pin from the guide hole.

8. A trailer tandem slide stopping device comprising:
a guide pin shaped complementarily to the holes of a plurality of holes positioned in an outer rail attached to a trailer, a guide hole amongst the plurality of holes being positioned either between a rearward end of an inner rail of the tandem trailer and a rear of the trailer or between a forward end of the inner rail and a front of the trailer, such that the guide pin is insertable by a first end into the guide hole, the guide pin being cylindrical;
a plate attached to a second end of the guide pin, wherein the plate is configured for abutting the outer rail upon insertion of the guide pin into the guide hole, the plate being circular;
wherein the guide pin is configured for abutting the rearward end or the forward end of the inner rail upon driving a semitruck hitched to the trailer in forward or reverse, respectively, for moving the trailer tandem toward the rear or front of the trailer, respectively, such that a locking pin attached to the trailer tandem is aligned with and positioned for insertion into a target hole of the plurality of holes, the target hole corresponding to a desired position of the trailer tandem relative to the trailer; and
a handle attached to the plate and being opposing to the guide pin, wherein the handle is configured for grasping in digits or a hand of the user, positioning the user for pulling on the handle for extracting the guide pin from the guide hole, the handle comprising a ring configured for insertion of a digit of the hand of the user, the ring, the guide pin, and the plate comprising steel.
